(19) United States
(12) Patent Application Publication
(10) Pub. No.: US 2015/0254794 A1
(43) Pub. Date: Sep. 10, 2015

(54) Estate Account Management

(71) Applicant: Estate Assist, Inc., San Francisco, CA (US)

(72) Inventors: Woodrow H. Levin, San Francisco, CA (US); Joseph G. Moss, Danville, CA (US)

(73) Assignee: Estate Assist, Inc., San Francisco, CA (US)

(21) Appl. No.: 14/329,152

(22) Filed: Jul. 11, 2014

Related U.S. Application Data
(60) Provisional application No. 61/949,894, filed on Mar. 7, 2014.

(51) Int. Cl. G06Q 50/18; G06Q 10/00

(52) U.S. Cl. CPC G06Q 50/186; G06Q 10/00

(57) ABSTRACT

Systems and methods for managing accounts associated with an estate. Estate data for an estate is received. The received estate data is verified. Closing data is generated for an account associated with the estate using the estate data. The closing data for the account is used to facilitate closing the account associated with the estate. In facilitating closing of the account associated with the estate, the closing data is sent to a first account system for the account to cause the account to be closed.

### CROSS-REFERENCE TO RELATED APPLICATIONS

This application claims priority to U.S. Provisional Patent Application No. 61/949,894, filed Mar. 7, 2014, entitled “ORGANIZING, TRANSMITTING, OR CLOSING ACCOUNTS ASSOCIATED WITH AN ESTATE,” which is incorporated by reference.

### BACKGROUND

An area of ongoing research and development is the management of estates. In particular problems exist when a person that is a subject of an estate dies or becomes incapacitated, and accounts of the person need to be acted upon by a person who has power to manage the estate. There therefore exists the need for systems and methods to allow a person to manage accounts associated with an estate.

Additionally, often times a person who has the power to manage an estate is unaware of many of the accounts that need to be acted upon. There therefore exists the need for systems and methods to allow a person to discover accounts associated with an estate of which they are unaware, to allow them to manage all of the accounts associated with the estate.

Other limitations of the relevant art will become apparent to those of skill in the art upon a reading of the specification and a study of the drawings.

### SUMMARY

The following implementations and aspects thereof are described and illustrated in conjunction with systems, tools, and methods meant to be exemplary and illustrative, not necessarily limiting in scope. In various implementations one or more of the above-described problems have been addressed, while other implementations are directed to other improvements.

Various implementations include systems and methods for managing accounts associated with an estate. In various implementations, estate data for an estate is received. In various implementations, the received estate data is verified. In various implementations, closing data is generated for an account associated with the estate using the estate data. In various implementations, the closing data for the account is used to facilitate closing the account associated with the estate. In various implementations, in facilitating closing of the account associated with the estate, the closing data is sent to a first account system for the account to cause the account to be closed.

These and other advantages will become apparent to those skilled in the relevant art upon a reading of the following descriptions and a study of the several examples of the drawings.

### BRIEF DESCRIPTION OF THE DRAWINGS

FIG. 1 depicts a diagram of an example of a system for managing accounts associated with an estate.

FIG. 2 depicts a diagram of an example of a system for performing automated estate account management.

FIG. 3 depicts a diagram of an example of a system for gathering estate data.

FIG. 4 depicts a diagram of an example of a system for discovering accounts associated with an estate.

FIG. 5 depicts a diagram of an example of a system for verifying estate data.

FIG. 6 depicts a diagram of an example of a system for closing an account associated with an estate.

FIG. 7 depicts a flowchart of an example of a method for managing accounts associated with an estate using estate data.

FIG. 8 depicts a flowchart of an example of a method for discovering an account associated with an estate and closing the account.

FIG. 9 depicts a flowchart of an example of a method for discovering an account associated with an estate using a financial account.

FIG. 10 depicts a flowchart of an example of a method for discovering an account associated with an estate based on a region associated with a person that is the subject of an estate.

### DETAILED DESCRIPTION

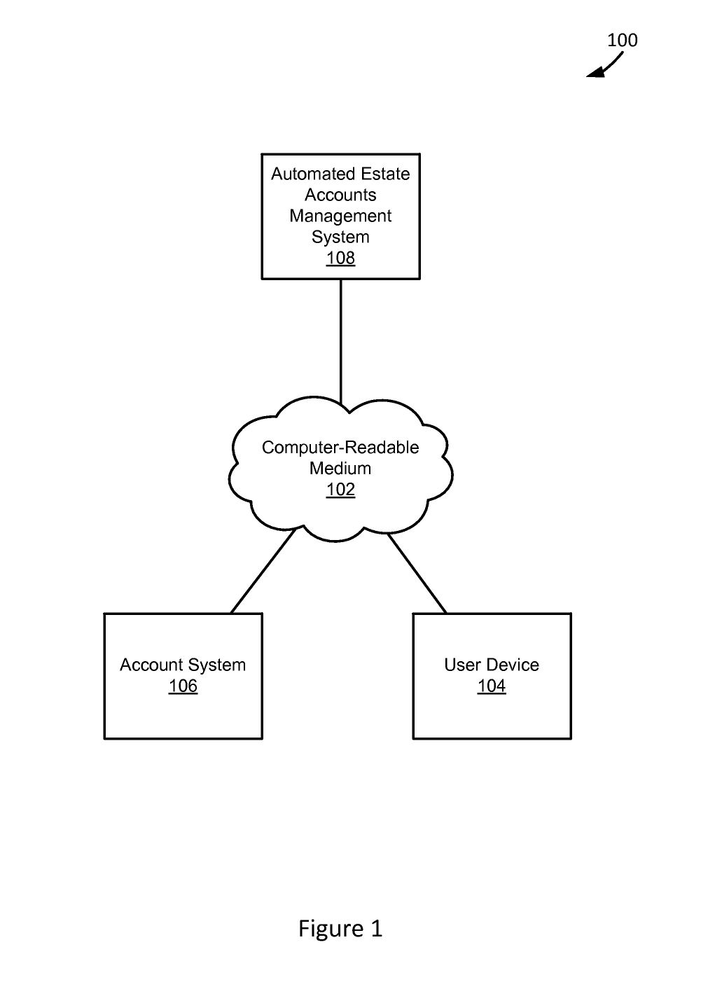

FIG. 1 depicts a diagram 100 of an example of a system for managing accounts associated with an estate. The system of the example of FIG. 1 includes a computer-readable medium 102, a user device 104, an account system 106, and an automated estate accounts management system 108.

The computer-readable medium 102 is intended to represent a variety of potentially applicable technologies. For example, the computer-readable medium 102 can be used to form a network or part of a network. Where two components are co-located on a device, the computer-readable medium 102 can include a bus or other data conduit or plane. Where a first component is co-located on one device and a second component is located on a different device, the computer-readable medium 102 can include a wireless or wired back-end network or LAN. The computer-readable medium 102 can also encompass a relevant portion of a WAN or other network, if applicable.

The user device 104, the account system 106, and the automated estate accounts management system 108 are coupled to each other through the computer-readable medium 102. As used in this paper, a “computer-readable medium” is intended to include all mediums that are statutory (e.g., in the United States, under 35 U.S.C. 101), and to specifically exclude all mediums that are non-statutory in nature to the extent the exclusion is necessary for a claim that includes the computer-readable medium to be valid. Known statutory computer-readable mediums include hardware (e.g., registers, random access memory (RAM), non-volatile (NV) storage, to name a few), but may or may not be limited to hardware.

The computer-readable medium 102, the user device 104, the account system 106, the automated estate accounts management system 108, and other applicable systems, or devices described in this paper can be implemented as a computer system, a plurality of computer systems, or parts of a computer system or a plurality of computer systems. A computer system, as used in this paper, is intended to be construed broadly. In general, a computer system will include a processor, memory, non-volatile storage, and an interface. A typical computer system will usually include at least a processor, memory, and a device (e.g., a bus) coupling the memory to the processor. The processor can be, for example, a general-purpose central processing unit (CPU), such as a microprocessor, or a special-purpose processor, such as a microcontroller.

The memory can include, by way of example but not limitation, random access memory (RAM), such as dynamic RAM (DRAM) and static RAM (SRAM). The memory can be local, remote, or distributed. The bus can also couple the processor to non-volatile storage. The non-volatile storage is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software on the computer system. The non-volatile storage can be local, remote, or distributed. The non-volatile storage is optional because systems can be created with all applicable data available in memory.

Software is typically stored in the non-volatile storage. Indeed, for large programs, it may not even be possible to store the entire program in the memory. Nevertheless, it should be understood that for software to run, if necessary, it is moved to a computer-readable location appropriate for processing, and for illustrative purposes, that location is referred to as the memory in this paper. Even when software is moved to the memory for execution, the processor will typically make use of hardware registers to store values associated with the software, and local cache that, ideally, serves to speed up execution. As used herein, a software program is assumed to be stored at an applicable known or convenient location (from non-volatile storage to hardware registers) when the software program is referred to as “implemented in a computer-readable storage medium.” A processor is considered to be “configured to execute a program” when at least one value associated with the program is stored in a register readable by the processor.

In one example of operation, a computer system can be controlled by operating system software, which is a software program that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage and causes the processor to execute the various acts required by the operating system to input and output data and to store data in the memory, including storing files on the non-volatile storage.

The bus can also couple the processor to the interface. The interface can include one or more input and/or output (I/O) devices. The I/O devices can include, by way of example but not limitation, a keyboard, a mouse or other pointing device, disk drives, printers, a scanner, and other I/O devices, including a display device. The display device can include, by way of example but not limitation, a cathode ray tube (CRT), liquid crystal display (LCD), or some other applicable known or convenient display device. The interface can include one or more of a modem or network interface. It will be appreciated that a modem or network interface can be considered to be part of the computer system. The interface can include an analog modem, isdn modem, cable modem, token ring interface, satellite transmission interface (e.g. “direct PC”), or other interfaces for coupling a computer system to other computer systems. Interfaces enable computer systems and other devices to be coupled together in a network.

The computer systems can be compatible with or implemented as part of or through a cloud-based computing system. As used in this paper, a cloud-based computing system is a system that provides virtualized computing resources, software and/or information to client devices. The computing resources, software and/or information can be virtualized by maintaining centralized services and resources that the edge devices can access over a communication interface, such as a network. “Cloud” may be a marketing term and for the purposes of this paper can include any of the networks described herein. The cloud-based computing system can involve a subscription for services or use a utility pricing model. Users can access the protocols of the cloud-based computing system through a web browser or other container application located on their client device.

A computer system can be implemented as an engine, as part of an engine, or through multiple engines. As used in this paper, an engine includes at least two components: 1) a dedicated or shared processor and 2) hardware, firmware, and/or software modules that are executed by the processor. Depending upon implementation-specific or other considerations, an engine can be centralized or its functionality distributed. An engine can include special purpose hardware, firmware, or software embodied in a computer-readable medium for execution by the processor. The processor transforms data into new data using implemented data structures and methods, such as is described with reference to the FIGS. in this paper.

The engines described in this paper, or the engines through which the systems and devices described in this paper can be implemented, can be cloud-based engines. As used in this paper, a cloud-based engine is an engine that can run applications and/or functionalities using a cloud-based computing system. All or portions of the applications and/or functionalities can be distributed across multiple computing devices, and need not be restricted to only one computing device. In some embodiments, the cloud-based engines can execute functionalities and/or modules that end users access through a web browser or container application without having the functionalities and/or modules installed locally on the end-users' computing devices.

As used in this paper, datastores are intended to include repositories having any applicable organization of data, including tables, comma-separated values (CSV) files, traditional databases (e.g., SQL), or other applicable known or convenient organizational formats. Datastores can be implemented, for example, as software embodied in a physical computer-readable medium on a general- or specific-purpose machine, in firmware, in hardware, in a combination thereof, or in an applicable known or convenient device or system. Datastore-associated components, such as database interfaces, can be considered “part of” a datastore, part of some other system component, or a combination thereof, though the physical location and other characteristics of datastore-associated components is not critical for an understanding of the techniques described in this paper.

Datastores can include data structures. As used in this paper, a data structure is associated with a particular way of storing and organizing data in a computer so that it can be used efficiently within a given context. Data structures are generally based on the ability of a computer to fetch and store data at any place in its memory, specified by an address, a bit string that can be itself stored in memory and manipulated by the program. Thus, some data structures are based on computing the addresses of data items with arithmetic operations; while other data structures are based on storing addresses of data items within the structure itself. Many data structures use both principles, sometimes combined in non-trivial ways. The implementation of a data structure usually entails writing a set of procedures that create and manipulate instances of that structure. The datastores, described in this paper, can be cloud-based datastores. A cloud-based datastore is a datastore that is compatible with cloud-based computing systems and engines.

In a specific implementation, the user device functions to send and receive data. In sending and receiving data, a user can send and receive estate data through the user device 104. Estate data can be used to manage accounts associated with an estate. As used in this paper, accounts associated with an estate include accounts of a person that is the subject of an estate. Depending upon implementation-specific or other considerations estate data sent and received through the user device 104 can be used to discover accounts associated with an estate. The user device 104 can include a graphical interface through which a user can interact with applications, including web-based applications, used in managing accounts associated with an estate. In managing accounts, a user, including either a person that is the subject of an estate, or a person with the power to manage the estate, can instruct the closure of accounts associated with an estate.

In a specific implementation, the account system 106 is part of a system of a provider of an account associated with an estate. For example, the account system 106 can be the system of a utility provider, a fitness provider, or a cable provider. The account system 106 can include an interface through which an account provider can send and receive data. Data sent and received by the account system 106 can be used to manage an account, e.g. inquire about a status of an account, or close an account. The account system 106 can include and/or provide an application through which systems and device can manage accounts provided for by the account system 106.

In a specific implementation, the automated estate accounts management system 108 functions to manage accounts associated with an estate. In managing accounts associated with an estate, the automated estate accounts management system 108 can function to determine whether an account associated with an estate is still open. Additionally, in managing accounts associated with an estate, the automated estate accounts management system 108 can function to gather and send data used to facilitate closing of an account associated with an estate.

In a specific implementation, the automated estate accounts management system 108 functions to receive estate data. Depending upon implementation-specific or other considerations, the automated estate accounts management system 108 can receive estate data from either or both the user device 104 and the account system 106. Estate data received by the automated estate accounts management system 108 can include personal data about a person that is the subject of an estate or people associated with the person that is the subject of the estate, financial data about the person that is the subject of the estate, account data about accounts associated with the estate, and deceased person data of the estate.

In a specific implementation, the automated estate accounts management system 108 functions to discover accounts associated with an estate. Depending upon implementation-specific or other considerations, the automated estate accounts management system 108 can determine accounts associated with an estate based on financial data. For example, the account discovery system can use financial information to log into a bank account of a person that is the subject of an estate, to determine accounts associated with the estate. Further depending upon implementation-specific or other considerations, the automated estate accounts management system 108 can determine accounts associated with an estate based on a region in which a person that is the subject of an estate resided. For example, the automated estate accounts management system 108 can determine a person that is the subject of an estate resided in a certain zip code and determine common accounts to other residents of the zip code to determine accounts associated with the estate.

In a specific implementation, the automated estate accounts management system 108 function to verify received estate data. In verifying estate information, the automated estate accounts management system 108 can verify deceased person data. Depending upon implementation-specific or other considerations, the automated estate accounts management system 108 can determine whether a death certificate of a person that is the subject of an estate is valid. Further depending upon implementation-specific or other considerations, the automated estate accounts management system 108 can determine whether a person responsible for managing an estate has the legal right to manage the estate. For example, automated estate accounts management system 108 can determine whether an instrument included as part deceased person data that specifies who has the legal right to manage the estate is a valid document.

In a specific implementation, the automated estate accounts management system 108 functions to close an account associated with an estate. As used in this paper, closing an account can include transferring the account to another person. In closing an account, the automated estate accounts management system 108 can determine requirements to close or transfer the account from account requirements included as part of account data for the account. In closing an account, the automated estate accounts management system 108 can generate closing data, according to account requirements for the account, and send the closing data to an account provider of the account, to facilitate closing of the account. Depending upon implementation-specific or other considerations, the automated estate accounts management system 108 can verify whether an account associated with an estate has been closed and resend closing data to facilitate closing of the account. Further depending upon implementation-specific or other considerations, automated estate accounts management system 108 functions to close an account associated with an estate after receiving instructions from a person responsible for managing the estate to close the account.

In an example of operation of the example system shown in FIG. 1, the user device 104 functions to send estate data to the automated estate account management system 108. In the example of operation of the example system shown in FIG. 1, the automated estate accounts management system 108 functions to close an account associated with an estate for which the estate data is received. Further, in the example of operation of the example system shown in FIG. 1, in closing the account, the automated estate accounts management system 108 functions to generate and send data to the account system 106 to facilitate closing the account.

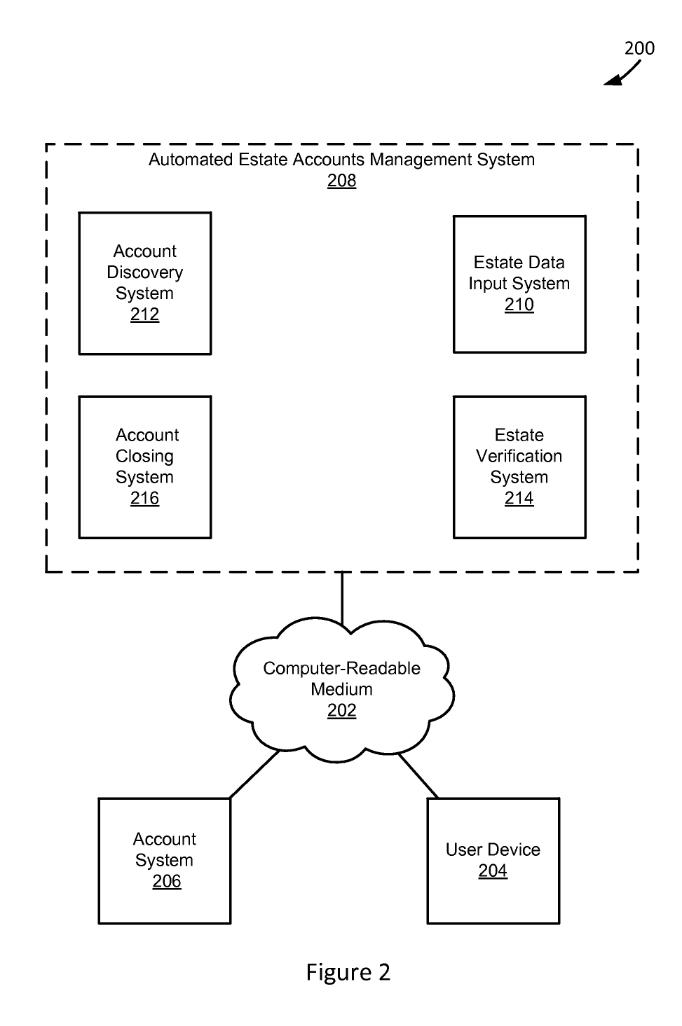

FIG. 2 depicts a diagram 200 of an example of a system for performing automated estate account management. The example system of FIG. 2 includes a computer-readable medium 202, a user device 204, an account system 206, and an automated estate accounts management system 208. In the example system shown in FIG. 2, the user device 204, the account system 206, and the automated estate accounts management system 208 are coupled to each other through the computer-readable medium 202.

In a specific implementation, the user device 204 functions according to an applicable device through which a user can send and receive data, such as the user devices described in this paper. In sending data through the user device 204, a user can send data, e.g. estate data, used in the management of accounts associated with an estate. In receiving data through the user device 204, a user can manage accounts associated with an estate. A user that uses the user device 204 can include a person that is the subject of an estate, and/or a person that is responsible for management of the estate, e.g. an executor of the estate.

In a specific implementation, the account system 206 functions according to an applicable system of an account provider, such as the account systems described in this paper. The account system 206 can be a system of an issuer or a provider of an account. For example, an account system 206 can be the system of a utility provider, a fitness provider, or a cable provider. While the system shown in FIG. 2 only includes one account system 206, multiple account systems can be coupled to the automated estate account management system 208. The account system 206 can include an interface through which an account provider can receive data from the automated estate accounts management system 206 and the user device 204. Data that is sent to the account system 206 can be used to manage an account, e.g. inquire about a status of an account, or close an account. Additionally, the account system 206 can include an interface through which the automated estate accounts management system 208 and the user device 204 can receive data from the account system 206. Data received from the account system 206 can be used to manage an account.

In a specific implementation, the automated estate accounts management system 208 functions according to an applicable system for automatically managing estate accounts, such as the automated estate accounts management systems described in this paper. In managing estate accounts, the automated estate accounts management system 208 can receive estate data, e.g. financial data about a person associated with an estate, data about an account, and deceased person data. The automated estate accounts management system 208 can function to discover accounts associated with an estate. Accounts associated with an estate can be accounts of a person that is the subject of the estate. In managing estate accounts, the automated estate accounts management system 208 can function to verify estate information. In verifying estate information, the automated estate accounts management system can verify whether a person that is the subject of an estate has in fact died and whether a person responsible for management of an estate does actually have power to manage the estate. The automated estate accounts management system 208 can function to close an account. The automated estate accounts management system 208 can close an account input by a user or an account discovered by the automated estate accounts management system 208.

In the example system shown in FIG. 2, the automated estate accounts management system 208 includes an estate data input system 210, an account discovery system 212, an estate verification system 214, and an account closing system 216. In a specific implementation, the estate data input system 210 functions to receive estate data. Depending upon implementation-specific or other considerations, the estate data input system 210 can receive estate data from either or both the user device 204 and the account system 206. For example, a user of the user device 204 can input estate data that is received by the estate data input system 210.

In a specific implementation, estate data received by the estate data input system 210 includes personal data. Depending upon implementation-specific or other considerations, personal data received by the estate data input system 210 can include personal data of either or both a person that is the subject of an estate and a person associated with the person that is the subject of the estate. A person associated with a person that is the subject of an estate can include a spouse of a person that is the subject of the estate, a child of the person that is the subject of an estate, and a relative of a person that is the subject of the estate. Personal data, as is used in this paper can include any applicable information used to identify, characterize, or otherwise describe a person, including a gender, a date of birth, an address, a zip code, and a social security number.

In a specific implementation, estate data received by the estate data input system 210 includes financial data. Financial data received by the estate data input system 210 can be financial information of a person that is the subject of an estate. Financial data can include an account number of a bank account or a credit account. Financial data received by the estate data input system 210 can also include login credentials that are used to login to an account and a region, e.g. zip code, associated with the account or a person that is the subject of an estate.

In a specific implementation, estate data received by the estate data input system 210 includes account data of accounts associated with an estate. As used herein, accounts associated with an estate include accounts of a person that is the subject of the estate. Account data can be received from the account system 206 and/or the user device 204. For example, a user of the user device 204 can input account data about a specific account. In another example, the account system 206 can send account data for a specific account discovered by the automated estate accounts management system 208. Account data received by the estate data input system 210 can include an identification of an account and account requirements for the account. Account requirements for an account can include necessary information and formats of information needed to close the account. For example, if an account provider requires a death certificate to close an account, then account requirements for the account can specify the death certificate is needed.

In a specific implementation, estate data received by the estate data input system 210 includes deceased person data. Deceased person data can include a death certificate of a deceased person that is the subject of an estate. Deceased person data can also include an instrument that indicates who legally has the right to manage an estate of the deceased person, e.g. an executor of an estate, and residential information of the deceased person, e.g. an address of the deceased person. Depending upon implementation-specific or other considerations, deceased person data can be received from a deceased person before they died or from a person responsible for management of an estate of the deceased person.

In a specific implementation, the account discovery system 212 functions to discover accounts associated with an estate. Accounts associated with an estate can include accounts of a person that is the subject of the estate. Depending upon implementation-specific or other considerations, the account discovery system 212 can determine accounts associated with an estate based on financial data or personal data included as part of estate data for the estate. For example, the account discovery system can use financial information to log into a bank account of a person that is the subject of an estate, to determine accounts associated with the estate. Further depending upon implementation-specific or other considerations, the account discovery system 212 can determine accounts associated with an estate based on a region in which a person is associated or resided. For example, the account discovery system 212 can determine a person that is the subject of an estate resided in a certain zip code and determine common accounts to other residents of the zip code to determine accounts associated with the estate.

In a specific implementation, the estate verification system 214 functions to verify estate information. In verifying estate information, the estate verification system 214 can verify deceased person data. Depending upon implementation-specific or other considerations, the estate verification system 214 can determine whether a death certificate of a person that is the subject of an estate is valid. Further depending upon implementation-specific or other considerations, the estate verification system 214 can determine whether a person responsible for managing an estate has the legal right to manage the estate. For example, the estate verification system 214 can determine whether an instrument included as part of deceased person data that specifies who has the legal right to manage the estate is a valid document.

In a specific implementation, the account closing system 216 functions to close an account associated with an estate. In closing an account, the account closing system 216 can determine requirements to close the account from account requirements included as part of account data for the account. For example, the account closing system 216 can determine what data is necessary to close an account and a format in which the data needs to be presented in order to close the account. In closing an account, the account closing system 216 can generate closing data, according to account requirements for the account, and send the closing data to an account provider of the account, to facilitate closing of the account. Depending upon implementation-specific or other considerations, the account closing system 216 can verify whether an account associated with an estate has been closed and resend closing data to facilitate closing of the account.

In a specific implementation, the account closing system 216 functions to close an account associated with an estate after receiving instructions from a person responsible for managing the estate to close the account. Depending upon implementation-specific or other considerations, the account closing system 216 can also function to close an account associated with an estate if the estate verification system 214 properly verifies estate information for the estate. For example, the account closing system 216 can be configured to close an account associated with an estate if the estate verification system 214 verifies a death certificate of a deceased person that is the subject of the estate. In another example, the account closing system 216 can be configured to close an account associated with an estate if the estate verification system 214 verifies a person responsible for managing the estate legally has the power to manage the estate.

In an example of operation of the example system shown in FIG. 2, the user device 204 functions to send data to and receive data from the automated estate accounts management system 208. In the example of operation of the example system shown in FIG. 2, the account system 206 functions to send data to and receive data from the automated estate accounts management system 208. Further, in the example of operation of the example system shown in FIG. 2, the estate data input system 210 functions to receive estate data for an estate from the user device 204 and the account system 206. In the example of operation of the example system shown in FIG. 2, the account discovery system 212 functions to discover accounts associated with the estate. Additionally, in the example of operation of the example system shown in FIG. 2, estate data input system 210 functions to receive account data about accounts associated with the estate discovered by the account discovery system 212. In the example of operation of the example system shown in FIG. 2, the estate verification system 214 functions to verify the estate data of the estate. Further, in the example of operation of the example system shown in FIG. 2, the account closing system 216 functions to close the account associated with the estate.

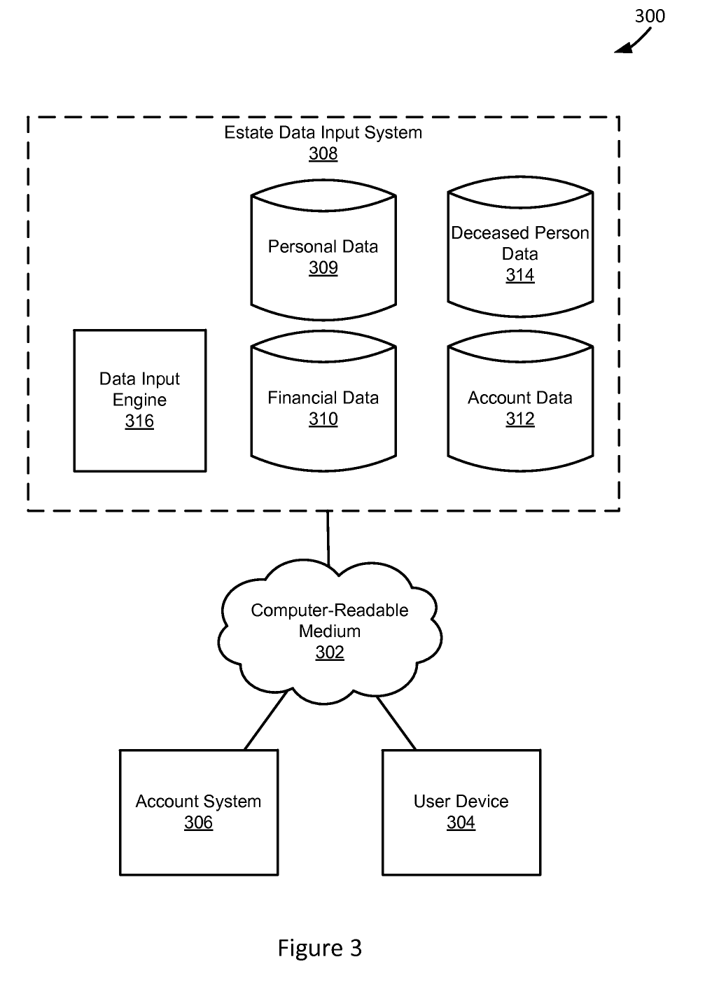

FIG. 3 depicts a diagram 300 of an example of a system for gathering estate data. The example system shown in FIG. 3 includes a computer-readable medium 302, a user device 304, an account system 306, and an estate data input system 308. In the example system shown in FIG. 3, the user device 304, the account system 306, and the estate data input system 308 are coupled to each other through the computer-readable medium 302.

In a specific implementation, the user device 304 functions according to an applicable device through which a user can send and receive data, such as the user devices described in this paper. In sending data through the user device 304, a user can send data, e.g. estate data, used in the management of accounts associated with an estate. In receiving data through the user device 304, a user can manage accounts associated with an estate. A user that uses the user device 304 can include a person that is the subject of an estate, and/or a person that is responsible for management of the estate, e.g. an executor of the estate.

In a specific implementation, the account system 306 functions according to an applicable system of an account provider, such as the account systems described in this paper. The account system 306 can be a system of an issuer of an account. For example, an account system 306 can be the system of a utility provider, a fitness provider, or a cable provider. While the system shown in FIG. 3 is shown to only include one account system 306, multiple account systems can be coupled to the estate data input system 308. The account system 306 can include an interface through which the account system 306 can receive data from the estate data input system 308 or the user device 304. The account system 306 can also include an interface through which the estate data input system 308 or the user device 304 can receive data from the account system 306. Data received from the account system 306 can be used to manage an account associated with an estate.

In a specific implementation, the estate data input system 308 functions according to an applicable system for receiving estate data, such as the estate data input systems described in this paper. Depending upon implementation-specific or other considerations, the estate data input system 308 can receive estate data from either or both the account system 306 and the user device 304.

In the example system shown in FIG. 3, the estate data input system 308 includes a personal data datastore 309, a financial data datastore 310, an account data datastore 312, a deceased person data datastore 314, and a data input engine 316. In a specific implementation, the personal data datastore 309 functions to store personal data that is included as part of estate data. The personal data datastore 309 can store personal data of either or both a person that is the subject of an estate and a person associated with the person that is the subject of the estate. A person associated with a person that is the subject of an estate can include a spouse of a person that is the subject of the estate, a child of the person that is the subject of an estate, and a relative of a person that is the subject of the estate. Personal data, as is used in this paper can include any applicable information used to identify, characterize, or otherwise describe a person, including a gender, a date of birth, an address, and a social security number.

In a specific implementation, personal data stored in the personal data datastore 309 is received from a user of a user device. Depending upon implementation-specific or other considerations, a person that is the subject of an estate can input personal data. Further depending upon implementation-specific or other considerations, a person associated with a person that is the subject of an estate and/or a person responsible for managing an estate can input personal data.

In a specific implementation, the financial data datastore 310 functions to store financial data. Financial data stored in the financial data datastore 310 can include financial data for a person that is the subject of an estate. Financial data can include an account number of a bank account or a credit account of a person. Depending upon implementation-specific or other considerations, financial data stored in the financial data datastore 310 can include login credentials used to login or gain access to a financial account. For example, financial data can include a username and password a person uses to gain access to a financial account. Further depending upon implementation-specific or other considerations, financial data stored in the financial datastore 310 can include a region, e.g. zip code, associated with an account or a person that is the subject of an estate. For example, financial data can include a region in which a person that is the subject of an estate resides.

In a specific implementation, financial data stored in the financial data datastore 310 is received from a user of a user device. Depending upon implementation-specific or other considerations, a person that is the subject of an estate can input financial data. Further depending upon implementation-specific or other considerations, a person associated with a person that is the subject of an estate and/or a person responsible for managing an estate can input financial data.

In a specific implementation, the account data datastore 312 functions to store account data. Account data stored in the account data datastore 312 can include an identification of an account and account requirements for closing the account. Depending upon implementation-specific or other considerations account data can be received from either or both the user device 304 or the account system 306. Further depending upon implementation-specific or other considerations, account data can be received for an account that is discovered or is input by a user. For example, a user can input an identification of an account and the account system 306 can input account data for the account based on the identification of the account. Account requirements for closing an account can include information that is necessary for an account system to close an account managed by the account system. Further depending upon implementation-specific or other considerations, account requirements for closing an account can include for example: that a death certificate is required, that proof of incapacitation is required, proof that a person that is the subject of an estate has moved, and/or authorization from the person that is the subject of the estate to close the account.

In a specific implementation, the deceased person data datastore 314 functions to store deceased person data. Deceased person data can include a death certificate of a deceased person that is the subject of an estate. Deceased person data can also include an instrument that indicates who legally has the right to manage an estate of the deceased person, e.g. an executor of an estate, and residential information of the deceased person, e.g. an address of the deceased person. Depending upon implementation-specific or other considerations, deceased person data can be received from the user device 304.

In a specific implementation, the data input engine 316 functions to receive estate data. Estate data received by the data input engine 316 can include financial data of a person that is the subject of an estate, account data of accounts associated with the estate, and deceased person data of the estate. The data input engine 316 can determine a data type, e.g. financial data, of received estate data and store the received estate data in the financial data datastore 310, the account data datastore 312, and the deceased person data datastore 314. Depending upon implementation-specific or other considerations, the data input engine 316 can receive estate data from either or both the user device 304 and the account system 306. Further depending upon implementation-specific or other considerations, the estate data input system 308 can receive estate data from either or both the user device 304 and the account system 306 after querying the user device 304 or the account system 306 for estate data. For example, the data input engine 316 can query the account system 306 for account data after receiving input from the user device 304 that includes an identification of an account associated with an estate.

In an example of operation of the example system shown in FIG. 3, the user device 304 and the account system 306 function to provide estate data to the data input engine 316. In the example of operation of the example system shown in FIG. 3, the data input engine 316 determines a data type of estate data received from the user device 304 and the account system 306. Further in the example of operation, the data input engine 316 stores the received estate data in one of the financial data datastore 310, the account data datastore 312, or the deceased person data datastore 314 based on a determined data type of the received estate data.

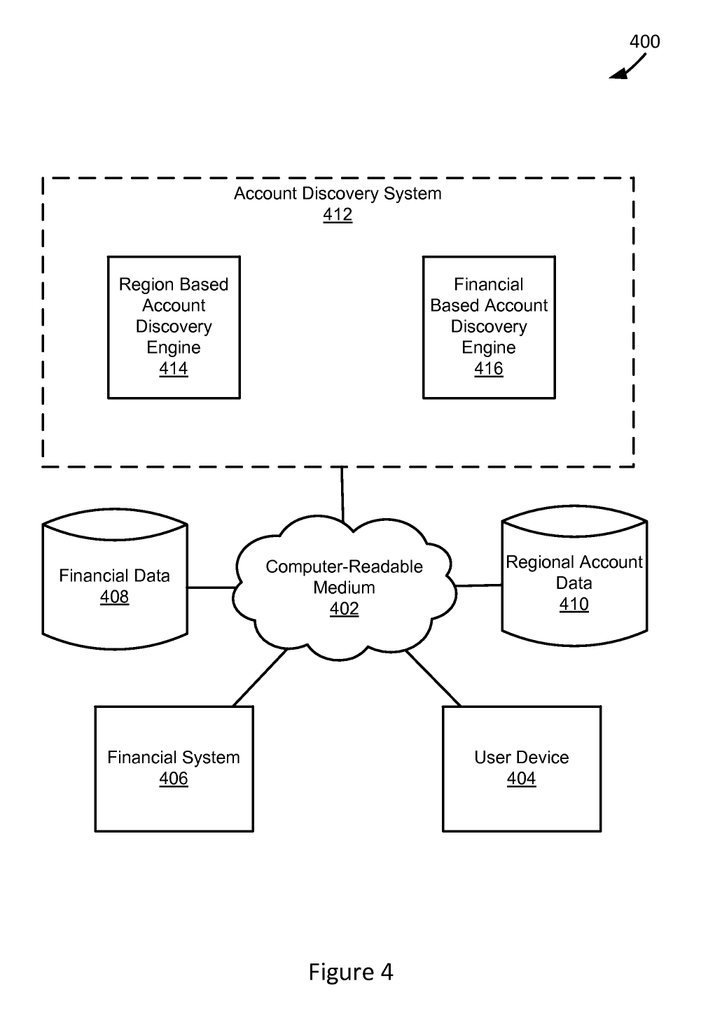

FIG. 4 depicts a diagram 400 of an example of a system for discovering accounts associated with an estate. The example system shown in FIG. 4 includes a computer-readable medium 402, a user device 404, a financial system 406, a financial data datastore 408, a regional account data datastore 410, and an account discovery system 412. In the example system shown in FIG. 4, the user device 404, the financial system 406, the financial data datastore 408, the regional account data datastore 410, and the account discovery system 412 are coupled to each other through the computer-readable medium 402.

In a specific implementation, the user device 404 functions according to an applicable device through which a user can send and receive data, such as the user devices described in this paper. In sending data through the user device 404, a user can send data, e.g. estate data, used in the management of accounts associated with an estate. In receiving data through the user device 404, a user can manage accounts associated with an estate. A user that uses the user device 404 can include a person that is the subject of an estate, and/or a person that is responsible for management of the estate, e.g. an executor of the estate.

In a specific implementation, the financial system 406 can be a system of a financial institution that provides a financial account to a person that is the subject of an estate. For example, a financial institution can be a bank that a person that is the subject of an estate has an account. The financial system 408 can include an interface through which access can be achieved to a financial account of a person that is the subject an estate. Depending upon implementation-specific or other considerations, access to a financial account can be achieved through an interface included as part of the financial system 406 using login credentials of a person that is the subject of an estate, as included as part of financial data. In accessing a financial account of a person that is the subject of an estate using the financial system 406, transactions made through the account by the person can be determined.

In a specific implementation, the financial data datastore 408 functions according to an applicable datastore for storing financial data, such as the financial data datastores described in this paper. Financial data stored in the financial data datastore 408 can include an account number of a financial account of a person that is the subject of an estate. Financial data stored in the financial data datastore 408 can also include login credentials that can be used to access a financial account of a person that is the subject of an estate. Depending upon implementation-specific or other considerations, financial data stored in the financial data datastore 408 can be stored temporarily for the length of a session of the user, to ensure that financial data is not stored in the applicable systems described in this paper, and decreasing the risks of potential data breaches for stored financial data.

In a specific implementation, the regional account data datastore 410 functions to store regional account data. Regional account data can include accounts that are commonly had by people in a specific region. For example, if a substantial number of people within a specific region have accounts with a specific utility provider then the regional account data can indicate that accounts with the specific utility provider are common in the region. Depending upon implementation-specific or other considerations, accounts that are commonly had by people in a specific region can be determined based on accounts associated with estates determined based on financial accounts of people that are the subject of the estates. For example, if accounts for a specific gym are discovered based upon financial accounts of people within a region that are the subject of estates, then the regional account data can indicate that accounts with the specific gym are common in the region. Further depending upon implementation-specific or other considerations, accounts that are commonly had by people in a specific region can be determined based on input from users. For example, if a substantial number of users within a region input account data, included as part of estate data, that indicates that they have an account with a specific gym, then the regional account data can indicate accounts with the specific gym are common in the region.

In a specific implementation, the account discovery system 412 functions according to an applicable system for discovering accounts associated with an estate, such as the account discovery systems described in this paper. Depending upon implementation-specific or other considerations, the account discovery system 412 can determine accounts associated with an estate based on financial data or personal data included as part of estate data for the estate. For example, the account discovery system can use financial information to log into a bank account of a person that is the subject of an estate, to determine accounts associated with the estate. Further depending upon implementation-specific or other considerations, the account discovery system 412 can determine accounts associated with an estate based on a region in which a person is associated or resided. Depending upon implementation-specific or other considerations, the account discovery system 412 can instruct an applicable data gathering system, such as the estate data input systems described in this paper, to collect account data for a discovered account associated with an estate.

In the example system shown in FIG. 4, the account discovery system 412 includes a region based account discovery engine 414 and a financial based account discovery engine 416. In a specific implementation, the region based account discovery engine 414 functions to determine an account associated with an estate based on a region associated with a person that is the subject of the estate. A region associated with a person that is the subject of an estate can include a region in which the person lives in or once lived. In determining accounts associated with an estate, depending upon implementation-specific or other considerations, the region based account discovery engine 414 can determine a region associated with a person that is the subject of the estate based on estate data for the estate. For example, the region based account discovery engine 414 can determine a region based on a bank statement of a user, included as part of financial data.

In a specific implementation, in determining accounts associated with an estate based on a region associated with a person that is the subject of the estate, the region based account discovery engine 414 can use regional account data stored in the regional account data datastore 410. The regional based account discovery engine 414 can use a determined region associated with a person that is the subject of an estate along with regional account data to determine accounts associated with an estate. For example, the regional based account discovery engine 414 can determine accounts that are common to people in a region that is associated with a person that is the subject of an estate are accounts associated with the estate.

In a specific implementation, the region based account discovery engine 414 can update regional account data stored in the regional account data datastore 410. In updating regional account data stored in the regional account data datastore 410, the region based account discovery engine can add accounts that are input by a person that is the subject of an estate and people associated with the person that is the subject of the estate. For example, if an executor of an estate inputs that a person that is the subject of the estate lives in a specific zip code and has a gym membership at a specific gym, then the region based account discovery engine 414 can update the regional account data to reflect that people that live in the specific zip code have gym memberships at the specific gym.

In a specific implementation, the region based account discovery engine 414 can verify whether an account that it discovers based on a region does in fact exist for a person that is the subject of an estate, and is therefore an account associated with the estate. In verifying a discovered account, the region based account discovery engine 414 can query an account provider of the account to verify whether the account does in fact exist for a person that is the subject of an estate. Depending upon implementation-specific or other considerations, the region based account discovery engine 414 can instruct an applicable data collection system not to gather account information for a discovered account, if the region based account discovery engine 414 verifies that the discovered account does not exist.

In a specific implementation, the financial based account discovery engine 416 functions to discover accounts associated with an estate based on financial data. Depending upon implementation-specific or other considerations, in discovering accounts associated with an estate based on financial data, the financial based account discovery engine 416 can access a financial account of a person that is the subject of the estate. The financial based account discovery engine 416 can access a financial account through the financial system 406 of the provider of the financial account using financial data stored in the financial data datastore 408. In discovering accounts of a person that is the subject of an estate, the financial based account discovery engine 416 can look at transactions in a financial account of the person. For example, if a financial account indicates that a person makes monthly transaction to a utility provider, then the financial based account discovery engine 416 can determine that an account with the utility provider is an account associated with an estate of which the person is the subject.

In a specific implementation, the financial based account discovery engine 416 can utilize financial information stored in an applicable financial data datastore during a session and then instruct the applicable financial data datastore to delete the financial information. For example, the financial based account discovery engine 416 can use financial information to access a financial system and then instruct a financial data datastore storing the financial data to delete the financial data.

In a specific implementation, the financial based account discovery engine 416 can discover accounts associated with an estate based upon personal data included as part of estate data for the estate. For example, the financial based account discovery engine 416 can discover accounts associated with an estate using an identification, e.g. social security number, of a person that is the subject of the estate or people associated with the person that is the subject of the estate. Depending upon implementation-specific or other considerations, the financial based account discovery engine 416 can discover accounts associated with an estate using personal data included as part of estate data for the estate and an applicable financial system. For example, the financial based account discovery engine 416 can provide an identification of a person that is the subject of an estate or people associated with a person that is the subject of an estate to an applicable financial system, e.g. a credit provider, and receive an identification of financial accounts associated with the estate from the applicable financial system.

In a specific implementation, the financial based account discovery engine 416 can verify whether an account that it discovers does in fact exist for a person that is the subject of an estate, and is therefore an account associated with the estate. In verifying a discovered account, the financial based account discovery engine 416 can query an account provider of the account to verify whether the account does in fact exist for a person that is the subject of an estate. Depending upon implementation-specific or other considerations, the financial based account discovery engine 416 can instruct an applicable data collection system not to gather account information for a discovered account, if the financial based account discovery engine 416 verifies that the discovered account does not exist.

In a specific implementation, the financial based account discovery engine 416 can update regional account data stored in the regional account data datastore 410 to indicate that a type of account is common to people within a region. In updating regional account data, the financial based account discovery engine 416 can update the regional account data if it discovers a specific account type, e.g. a gym membership to a specific gym, for a certain number of people within a region, using financial data. For example, the financial based account discovery engine 416 can if the financial based account discovery engine 416, over time, determines that 100 people within a zip code have accounts at a specific gym using financial data, then the financial based account discovery engine 416 can update regional account data stored in the regional account data datastore 410 to indicate that accounts with the specific gym are common to people within the zip code.

In an example of operation of the example system shown in FIG. 4, the financial data datastore 408 functions to store financial data included as part of estate data. In the example of operation of the example system shown in FIG. 4, the regional account data datastore 410 stores regional account data. Further, in the example of operation of the example system shown in FIG. 4, the region based account discovery engine functions to determine accounts associated with an estate based on a region associated with a person that is the subject of the estate and the regional account data stored in the regional account data datastore 410. In the example of operation of the example system shown in FIG. 4, the financial based account discovery engine 416 functions to determine accounts associated with an estate based on a financial account of a person that is the subject of the estate.

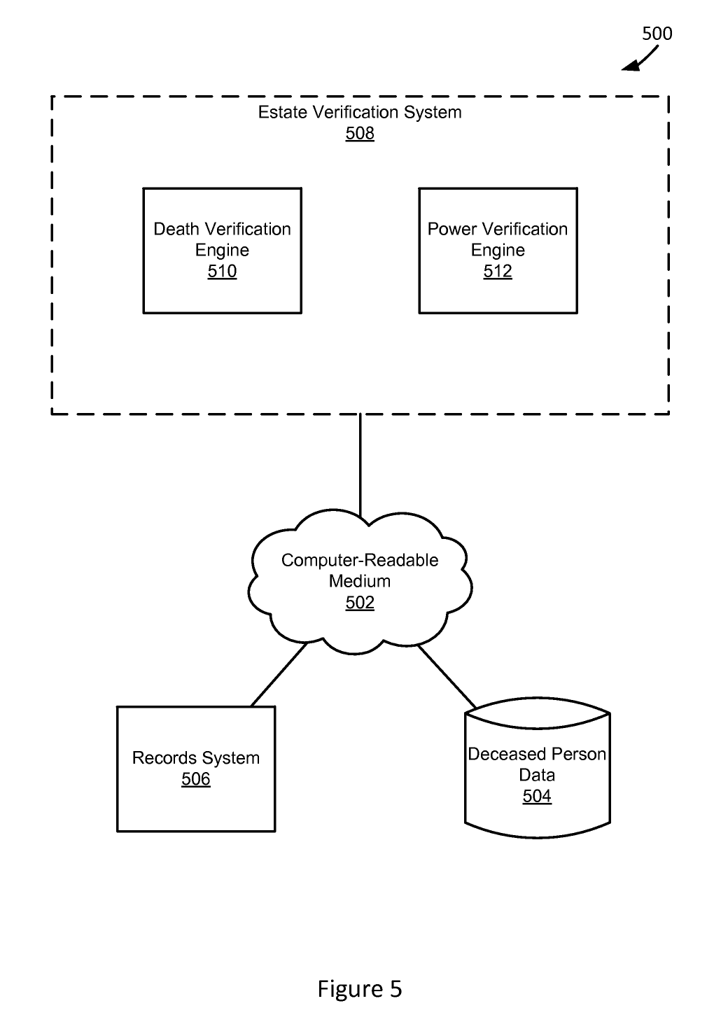

FIG. 5 depicts a diagram 500 of an example of a system for verifying estate data. The example system shown in FIG. 5 includes a computer-readable medium 502, a deceased person data datastore 504, a records system 506, and an estate verification system 508. In the example system shown in FIG. 5, the deceased person data datastore 504, the records system 506, and the estate verification system 508 are coupled to each other through the computer-readable medium 502.

In a specific implementation, the deceased person data datastore 504 functions according to an applicable datastore for storing deceased person data, such as the deceased person data datastores described in this paper. Deceased person data stored in the deceased person data datastore 504 can include a death certificate of a deceased person that is the subject of an estate. Deceased person data can also include an instrument that indicates who legally has the right to manage an estate of the deceased person, e.g. an executor of an estate, and residential information of the deceased person, e.g. an address of the deceased person.

In a specific implementation, the records system 506 functions according to an applicable system for storing records and facilitating access to records. The records system 506 can be part of or facilitate access to public records. For example, the records system 506 can be part of or facilitate access to county records, state records, and court records. Depending upon implementation-specific or other considerations, the records system 506 includes or facilitates access to deaths within a region, and/or an identification of people who are legally responsible for management of estates of dead people.

In a specific implementation, the estate verification system 508 functions according to an applicable system for verifying estate data. The estate verification system 508 can verify deceased person data stored in the deceased person data datastore 504 and included as part of estate data. Depending upon implementation-specific or other considerations, in verifying estate data, the estate verifications system 508 can verify whether a person has in fact died and whether a person legally has responsibility for managing an estate of which a deceased person is the subject.

In the example system shown in FIG. 5, the estate verification system 508 includes a death verification engine 510 and a power verification engine 512. In a specific implementation, the death verification engine 510 functions to determine whether a person who is the subject of an estate has in fact died. In determining whether a person who is the subject of an estate has in fact died, the estate verification system 508 can use a death certificate, included as part of deceased person data, to determine an identification of the person. Further in determining whether a person who is the subject of an estate has in fact died, the estate verification system 508 can obtain records from the records system 506 to determine whether the person has in fact died. For example, the death verification engine 510 can look up death records of a region to determine whether the person identified from a death certificate included as part of deceased person data has in fact died.

In a specific implementation, the power verification engine 512 functions to determine whether a person legally has power to manage an estate. The power verification engine 512 can use deceased person data to determine an identification of a person who purports to legally have responsibility for managing an estate of which a deceased person is the subject. The power verification engine 512 can use a determine identity of a person to check with records obtained from the records system 506 to determine whether the person does actually legally have the power to manage an estate. For example, the power verification engine 512 can obtain a testamentary document from court records through the records system 506 to determine whether a person identified through deceased person data 504, legally has power to manage an estate.

In an example of operation of the example system shown in FIG. 5, the deceased person data datastore 504 functions to stored deceased person data, including a death certificate of a person that is the subject of an estate and a document that indicates that a person has power to manage the estate. In the example of operation of the example system shown in FIG. 5, the records system 506 functions to provide access to public records. Further, in the example of operation of the example system shown in FIG. 5, the death verification engine 510 functions to determine whether the person that is the subject of the estate has in fact died using records obtained through the records system 506. In the example of operation of the example system shown in FIG. 5, the power verification engine 512 functions to determine whether the person identified through the deceased person data as having the power to manage the estate, does in fact legally have power to manage the estate using records obtained through the records system 506.

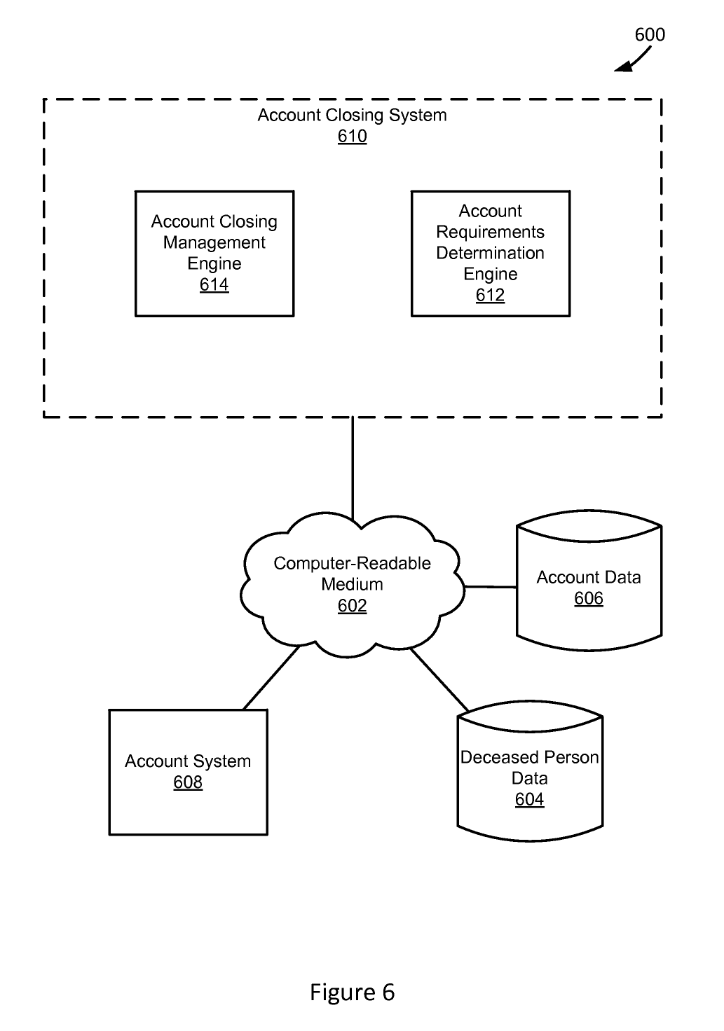

FIG. 6 depicts a diagram 600 of an example of a system for closing an account associated with an estate. The example system shown in FIG. 6 includes a computer-readable medium 602, a deceased person data datastore 604, an account data datastore 606, an account system 608, and an account closing system 610. In the example system shown in FIG. 6, the deceased person data datastore 604, the account data datastore 606, the account system 608, and the account closing system 610 are coupled to each other through the computer-readable medium 602.

In a specific implementation, the deceased person data datastore 604 functions according to an applicable datastore for storing deceased person data, such as the deceased person data datastores described in this paper. Deceased person data stored in the deceased person data datastore 604 can include a death certificate of a deceased person that is the subject of an estate. Deceased person data can also include an instrument that indicates who legally has the right to manage an estate of the deceased person, e.g. an executor of an estate, and residential information of the deceased person, e.g. an address of the deceased person.

In a specific implementation, the account data datastore 606 functions according to an applicable datastore for storing account data, such as the account data datastore described in this paper. Account data stored in the account data datastore 606 can include an identification of an account and account requirements for the account.

In a specific implementation, the account system 608 functions according to an applicable system for an account provider, such as the account systems described in this paper. The account system 608 can be a system of an issuer or a provider of an account. For example, an account system 608 can be the system of a utility provider, a fitness provider, or a cable provider. The account system 608 can include an interface through which an account provider can receive data, e.g. an electronic fax, that is used to close an account provided by the account provider.

In a specific implementation, the account closing system 610 functions according to an applicable system for closing an account associated with an estate, such as the account closing systems described in this paper. The account closing system 610 can function to close an account associated with an estate after receiving instructions from a person responsible for managing the estate to close the account. Depending upon implementation-specific or other considerations, the account closing system 610 can also function to close an account associated with an estate if estate information for the estate is verified. For example, the account closing system 610 can be configured to close an account associated with an estate if a death certificate of a deceased person that is the subject of the estate is verified to be authentic. In another example, the account closing system 610 can be configured to close an account associated with an estate if a person responsible for managing the estate is verified to legally have the power to manage the estate.

In the example system shown in FIG. 6, the account closing system 610 includes an account requirements determination engine 612 and an account closing management engine 614. In a specific implementation, the account requirements determination engine 612 functions to determine account requirements for an account associated with an estate. Account requirements for an account can include necessary information and formats of information needed to close the account. Depending upon implementation-specific or other considerations, the account requirements determination engine 612 can determine account requirements for an account either or both from account data stored in the account data datastore 606 or from the account system 608. For example, the account requirements determination engine 612 can query the account system 608 for account requirements of an account that is provided by the account system 608. In another example, the account requirements determination engine 612 can determine account requirements specifying that proof a person that is the subject of an estate, or authorization from a person that is the subject of the estate is necessary to close an account associated with the estate.

In a specific implementation, the account closing management engine 614 functions to manage closing of an account associated with an estate. In closing an account, the account closing management engine 614 can gather and send necessary data to an account system 608 to facilitate closing of the account. Depending upon implementation-specific or other considerations, in closing an account associated with an estate, the account closing management engine 614 can generate closing data, e.g. an electronic fax, that is sent to an account system 608 and used to facilitate closing of the account. The account closing management engine 614 can gather data necessary to close an account from deceased person data stored in the deceased person data datastore 604 and account data stored in the account data datastore 606 to generate closing data. The account closing management engine 614 can gather and send the data according to account requirements for an account, as determined by the account closing requirements determination engine 612. For example, if account requirements specify that a copy of a death certificate needs to be sent to an account provider to close an account, then the account closing management engine 614 can gather and send a copy of the death certificate to the account system 608. In another example, if account requirements specify that a the data needs to be received in a specific format in order to close an account, then the account closing management engine 614 can send data in the specific format to the account system 608.

In a specific implementation, the account closing management engine 614 can be configured to close an account associated with an estate if the account closing management engine 614 receives instructions to close an account from a person with the power to manage the estate. Depending upon implementation-specific or other considerations, the account closing management engine 614 can be configured to close an account associated with an estate if a death certificate of a person that is the subject of the estate is verified and it is determined that the person is in fact dead. Further depending upon implementation-specific or other considerations, the account closing management engine 614 can be configured to close an account associated with an estate if it is verified that a person with the power to manage the estate does in fact legally have the power to manage the estate.

In a specific implementation, the account closing management engine 614 functions to determine if an account associated with an estate has actually been closed after data is sent to the account system 608 to cause the account to be closed. Depending upon implementation-specific or other considerations, the account closing management engine 614 can resend data used to facilitate closing of an account to the account system 608 if it determines that an account associated with an estate has not been closed.

In an example of operation of the example system shown in FIG. 6, the account closing requirements determination engine 612 functions to determine account closing requirements for an account associated with an estate from either or both the account system 608 and account data stored in the account data datastore 606. In the example of operation of the example system shown in FIG. 6, the account closing management engine 614 functions to provide data, including deceased person data stored in the deceased person data datastore 604, in accordance with the determined account requirements, to the account system 608, to cause the account to close.

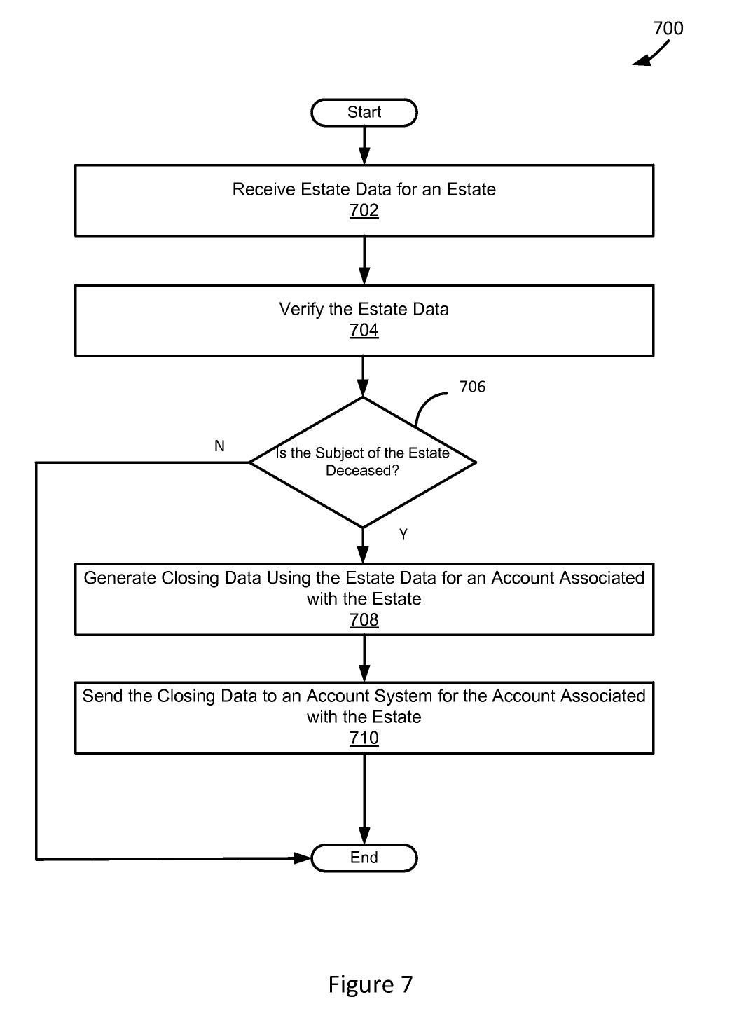

FIG. 7 depicts a flowchart 700 of an example of a method for managing accounts associated with an estate using estate data. The flowchart 700 begins at module 702 where estate data for an estate is received. Estate data received at module 702 can include financial data, account data, or deceased person data. Estate data can be received at module 702 from either or both a user device or an account system. Depending upon implementation-specific or other considerations, estate data can be received at module 702 from either or both a person that has the power to manage an estate and a person who is the subject of the estate.

The flowchart 700 continues to module 704 where the received estate data is verified. In verifying estate data, estate data received at module 702 can be checked to determine whether it is valid. Depending upon implementation-specific or other considerations, in verifying estate data, it can be determined whether deceased person data included as part of the estate data is valid. In determining whether estate data is valid, it can be determined whether a death certificate included as part of estate data is valid based upon records included as part of a records system. Further, in determining whether estate data is valid, it can be determined whether a power granted to a person who purports power over an estate is valid based upon records included as part of a records system.

The flowchart 700 continues to decision point 706, where it is determined whether a person who is the subject of the estate is deceased. An identification of a person who is the subject of the estate can be determined from the estate data received at module 702. For example, an identification of the person who is the subject of the estate can be determined from a death certificate that is included as part the estate data. In determining whether a person who is the subject of the estate is deceased, an identification of the person can be looked up in public records to determine if the person is actually deceased.

If it is determined at decision point 706 that the person who is the subject of the estate is deceased, then the flowchart 700 continues to module 708. At module 708, closing data for closing an account associated with the estate is generated using the estate data for the estate. For example, closing data can be generated that includes a copy of a death certificate that is included as part of the estate data. Depending upon implementation-specific or other considerations, closing data can be generated in accordance with account requirements for an account associated with the estate. For example, if account requirements for an account associated with the estate require that a death certificate and a statement by a person with the power to manage the estate is necessary to close the account, then closing data can be generated that includes the death certificate and the statement.

The flowchart 700 continues to module 710 where the closing data is sent to an account system for the account associated with the estate. Depending upon implementation-specific or other considerations, the closing data can be sent to an account system as an electronic fax. The closing data can be used to close the account or facilitate closing of the account by a provider of the account.

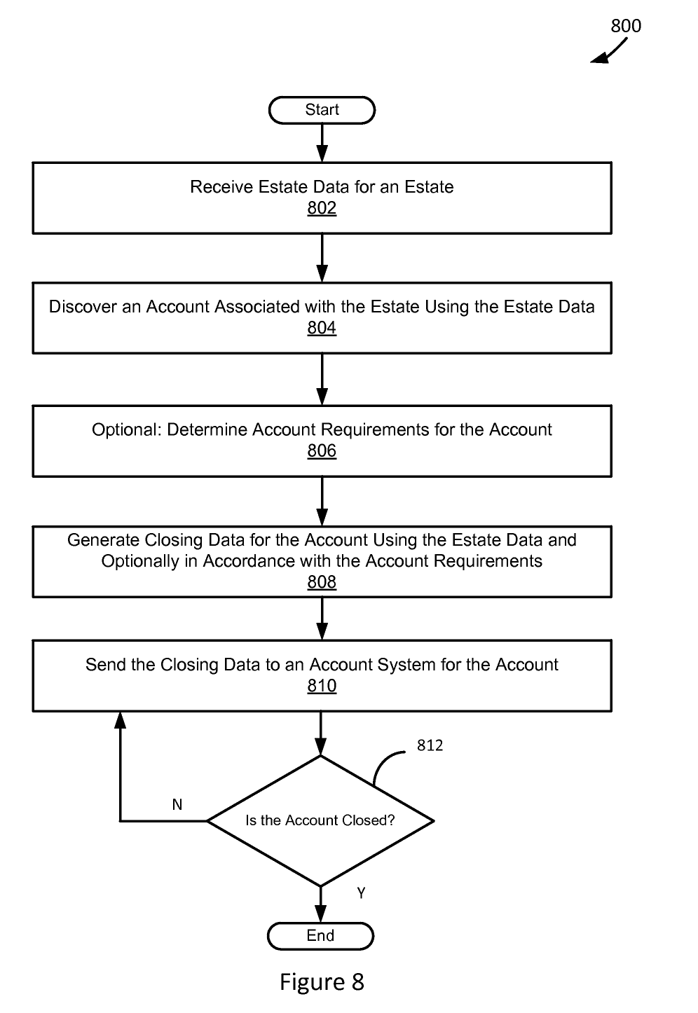

FIG. 8 depicts a flowchart 800 of an example of a method for discovering an account associated with an estate and closing the account. The flowchart 800 begins at module 802, where estate data for an estate is received. Estate data received at module 802 can include financial data, account data, or deceased person data. Estate data can be received at module 802 from either or both a user device or an account system. Depending upon implementation-specific or other considerations, estate data can be received at module 802 from either or both a person that has the power to manage an estate and a person who is the subject of the estate.

The flowchart 800 continues to module 804, where an account associated with the estate is discovered using the estate data. Depending upon implementation-specific or other considerations, a region associated with a person that is the subject of an estate can be determined from the estate data and used to discover accounts associated with the estate. For example, if it is determined that a person that is subject of an estate resided in a specific zip code, and that a substantial number of people in the zip code have an account with a specific utility provider, then it can be determined that the person that is the subject of the estate has an account with the specific utility provider. Further depending upon implementation-specific or other considerations, using estate data, a financial account of a person that is the subject of an estate can be determined and used to discover accounts associated with the estate.

The flowchart 800 optionally continues to module 806 where account requirements are determined for the account associated with the estate discovered at module 804. Account requirements can be determined from a provider of the account. Account requirements can specify what data is required and a format of the data for closing the account.

The flowchart 800 continues to module 808 where closing data is generated for the account using the estate data. For example, closing data can be generated that includes a copy of a death certificate that is included as part of the estate data. At module 808, the closing data can be optionally generated in accordance with account requirements determined at module 806.

The flowchart 800 continues to module 810 where the closing data generated at module 808 is sent to an account system for the account. Depending upon implementation-specific or other considerations, the closing data can be sent to an account system as an electronic fax. The closing data can be used to close the account or facilitate closing of the account by a provider of the account.

The flowchart 800 continues to decision point 812 where it is determined whether the account is closed. Depending upon implementation-specific or other considerations, it can be determined whether the account has been closed after a specific amount of time has passed since the closing data was sent to the account system at module 810. For example, it can be determined if the account has been closed a week after the closing data was sent to the account system. If it is determined at decision point 812 that the account has not been closed, then the flowchart can continues back to module 810, where the closing data can be resent to the account system for the account.

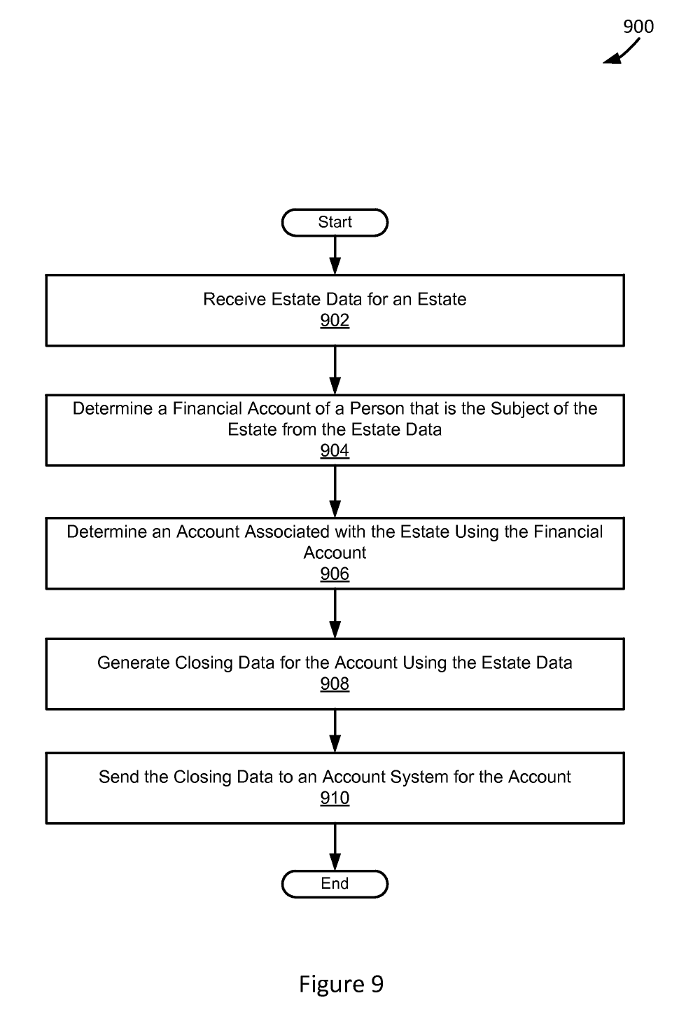

FIG. 9 depicts a flowchart 900 of an example of a method for discovering an account associated with an estate using a financial account. The flowchart 900 begins at module 902, where estate data is received for an estate. Estate data received at module 902 can include financial data, account data, or deceased person data. Estate data can be received at module 902 from either or both a user device or an account system. Depending upon implementation-specific or other considerations, estate data can be received at module 902 from either or both a person that has the power to manage an estate and a person who is the subject of the estate.

The flowchart 900 continues to module 904, where a financial account of a person that is the subject of the estate is determined from the estate data. A financial account can include a bank account or a credit account. Depending upon implementation-specific or other considerations, a financial account can be determined based on financial data that is included as part of estate data.

The flowchart 900 continues to module 906, where an account associated with the estate using the financial account determined at module 904. In determining an account associated with the estate, the financial account can be accessed to determine an account provider who provides an account associated with the estate, to which payments are made. For example, if the financial account indicates that payments are made to a utility provider, then it can be determined that an account with the utility provider is an account associated with the estate. Depending upon implementation-specific or other considerations, financial data that includes login credentials can be used to access the financial account.

The flowchart 900 continues to module 908, where closing data is generated for the account using the estate data. For example, closing data can be generated that includes a copy of a death certificate that is included as part of the estate data. Depending upon implementation-specific or other considerations, closing data can be generated in accordance with account requirements for the account associated with the estate.

The flowchart 900 continues to module 910 where the closing data generated at module 908 is sent to an account system for the account. Depending upon implementation-specific or other considerations, the closing data can be sent to an account system as an electronic fax. The closing data can be used to close the account or facilitate closing of the account by a provider of the account.

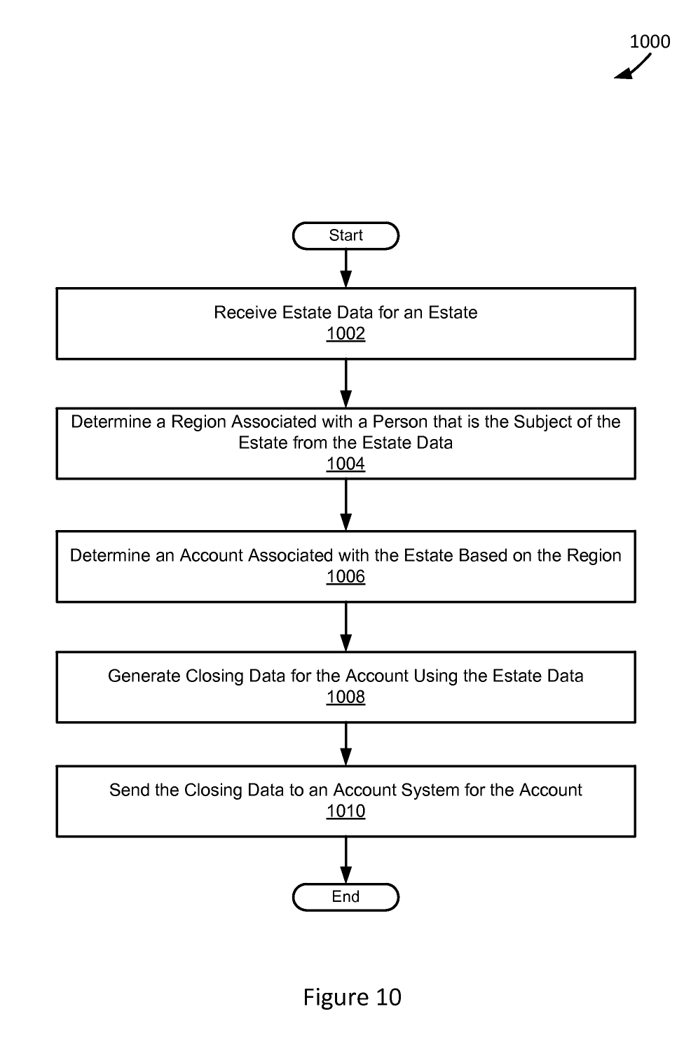

FIG. 10 depicts a flowchart 1000 of an example of a method for discovering an account associated with an estate based on a region associated with a person that is the subject of an estate. The flowchart 1000 begins at module 1002 where estate data is received for an estate. Estate data received at module 1002 can include financial data, account data, or deceased person data. Estate data can be received at module 1002 from either or both a user device or an account system. Depending upon implementation-specific or other considerations, estate data can be received at module 1002 from either or both a person that has the power to manage an estate and a person who is the subject of the estate.

The flowchart 1000 continues to module 1004, where a region associated with a person that is the subject of the estate is determined. A region associated with a person that is the subject of the estate can include a region in which the person resided or owned property. A region associated with the person that is the subject of the estate can be determined from estate data. For example, a financial account can be accessed or a death certificate can be used to determine a region associated with a person that is the subject of the estate. In another example, a region associated with a person can be determined from public records.

The flowchart 1000 continues to module 1006, where an account associated with the estate is determined based on the region associated with the person that is the subject of the estate. An account associated with the estate can be determined based on the region associated with the person using regional account data. For example, if regional account data indicates that people in the region have accounts with a specific utility provider, then it can be determined that an account associated with the estate is an account with the specific utility provider.

The flowchart 1000 continues to module 1008 where closing data is generated for the account using the estate data. For example, closing data can be generated that includes a copy of a death certificate that is included as part of the estate data. Depending upon implementation-specific or other considerations, closing data can be generated in accordance with account requirements for the account associated with the estate.

The flowchart 1000 continues to module 1010 where the closing data generated at module 1008 is sent to an account system for the account. Depending upon implementation-specific or other considerations, the closing data can be sent to an account system as an electronic fax. The closing data can be used to close the account or facilitate closing of the account by a provider of the account.

These and other examples provided in this paper are intended to illustrate but not necessarily to limit the described implementation. As used herein, the term “implementation” means an implementation that serves to illustrate by way of example but not limitation. The techniques described in the preceding text and figures can be mixed and matched as circumstances demand to produce alternative implementations.

We claim:

1. A method comprising:
receiving estate data for an estate;
verifying the estate data is valid;
generating first closing data for a first account associated with the estate using the estate data, the first closing data for the first account associated with the estate used to facilitate closing of the first account associated with the estate;
sending the first closing data to a first account system for the first account associated with the estate to cause closing of the account associated with the estate.

2. The method of claim 1, wherein the estate data includes a death certificate of a person that is a subject of the estate, verifying that the estate data is valid, further comprising, determining whether the person that is the subject of the estate is deceased using public records.

3. The method of claim 1, wherein the estate data includes account information of the first account associated with the estate, the account information of the first account associated with the estate used to determined account requirements for closing the first account associated with the estate, the first closing data generated in accordance with the account requirements.

4. The method of claim 1, further comprising:
discovering a second account associated with the estate using the estate data;
receiving account information for the second account associated with the estate;
generating second closing data for the second account associated with the estate using the estate data for the estate and the account information for the second account associated with the estate, the second closing data for the second account associated with the estate used to facilitate closing of the second account associated with the estate;
sending the second closing data to a second account system for the second account associated with the estate to cause closing of the second account associated with the estate.

5. The method of claim 4, wherein discovering the second account associated with the estate using the estate data further comprising:
determining a financial account of a person that is a subject of the estate using the estate data for the estate;
determining the second account associated with the estate using the financial account of the person that is the subject of the estate.

6. The method of claim 5, further comprising:
determining a region associated with the person that is the subject of the estate using the estate data for the estate;
updating regional account data based on the region associated with the person that is the subject of the estate and a second account associated with the estate to include the second account associated with the estate, the regional account data used to discover accounts associated with estates based on regions.

7. The method of claim 4, wherein discovering the second account associated with the estate using the estate data further comprising:
determining a region associated with a person that is a subject of the estate using the estate data for the estate;
determining the second account associated with the second account based on the region associated with the person that is the estate and regional account data for the region associated with the person that is the subject of the estate.

8. The method of claim 1, wherein the estate data includes an instrument that identifies a person that purports to have power to manage the estate, verifying that the estate data is valid further comprising, determining whether the person that purports to have power to manage the estate does have power to manage the estate.

9. The method of claim 1, further comprising:
determining whether the first account associated with the estate is closed;
resending the first account closing data to the first account system of the first account associated with the estate if it is determined that the first account associated with the estate is not closed.

10. The method of claim 1, further comprising, denying sending the first closing data to the first account system of the first account associated with the estate if it is determined that the person that purports to have power to manage the estate lacks the power to manage the estate.

11. A system comprising:
a data input engine configured to receive estate data for an estate;
an estate verification system configured to verify that the estate data is valid;
an account closing management engine configured to:
generate first closing data for a first account associated with the estate using the estate data, the first closing data for the first account associated with the estate used to facilitate closing of the first account associated with the estate;
send the first closing data to a first account system for the first account associated with the estate to cause closing of the account associated with the estate.

12. The system of claim 11, wherein the estate data includes a death certificate of a person that is a subject of the estate, and the estate verification system is further configured to determine whether the person that is the subject of the estate is deceased using public records.

13. The system of claim 11, wherein the estate data includes account information of the first account associated with the estate, the system further comprising:
an account requirements determination engine configured to determine account requirements for closing the first account associated with the estate using the account information of the first account associated with the estate;
the account closing management engine further configured to generate the first closing data generated in accordance with the account requirements.

14. The system of claim 11, further comprising:
an account discovery system configured to discover a second account associated with the estate using the estate data;
the data input engine further configured to receive account information for the second account associated with the estate;
the account closing management engine further configured to:
generate second closing data for the second account associated with the estate using the estate data for the estate and the account information for the second account associated with the estate, the second closing data for the second account associated with the estate used to facilitate closing of the second account associated with the estate;
send the second closing data to a second account system for the second account associated with the estate to cause closing of the second account associated with the estate.

15. The system of claim 14, wherein the account discovery system comprises a financial based account discovery engine configured to:
determine a financial account of a person that is a subject of the estate using the estate data for the estate;
determine the second account associated with the estate using the financial account of the person that is the subject of the estate.

16. The system of claim 15, wherein the account discovery system is further configured to:
determine a region associated with the person that is the subject of the estate using the estate data for the estate;
update regional account data based on the region associated with the person that is the subject of the estate and a second account associated with the estate to include the second account associated with the estate, the regional account data used to discover accounts associated with estates based on regions.

17. The system of claim 14, wherein the account discovery system further comprises a region based account discovery system configured to:
determine a region associated with a person that is a subject of the estate using the estate data for the estate;
determine the second account associated with the second account based on the region associated with the person that is the estate and regional account data for the region associated with the person that is the subject of the estate.

18. The system of claim 11, wherein the estate data includes an instrument that identifies a person that purports to have power to manage the estate, the estate verification system further configured to determine whether the person that purports to have power to manage the estate does have power to manage the estate.

19. The system of claim 11, wherein the account closing management engine is further configured to:
determine whether the first account associated with the estate is closed;
resend the first account closing data to the first account system of the first account associated with the estate if it is determined that the first account associated with the estate is not closed.

20. A system comprising:
means for receiving estate data for an estate;
means for verifying that the estate data is valid;
means for generating first closing data for a first account associated with the estate using the estate data, the first closing data for the first account associated with the estate used to facilitate closing of the first account associated with the estate;
means for sending the first closing data to a first account system for the first account associated with the estate to cause closing of the account associated with the estate.
